(19) United States
(12) Patent Application Publication
(10) Pub. No.: US 2007/0009617 A1
(43) Pub. Date: Jan. 11, 2007

(54) Method for preventing fungal growth in plants

(76) Inventor: Robert McDonald, San Antonio, TX (US)

Correspondence Address: DAVID G. HENRY, 418 RIVERVIEW DRIVE, WOODWAY, TX, 76712, US

(21) Appl. No.: 10/564,242

(22) PCT Filed: Jul. 8, 2004
(86) PCT No.: PCT/US04/21950

§ 371 Date: Sep. 11, 2006

(30) Foreign Application Priority Data
Jul. 11, 2003 (US) 10618354

(51) Int. Cl. A01N 65/00

(52) U.S. Cl. 424/754

(57) ABSTRACT

A natural, garlic extract-based fungicide and associated method of use which, as an alternative to conventional use of synthetic chemical fungicides, provides effective prevention and eradication of fungal infestation by a wide spectrum of fungal species.

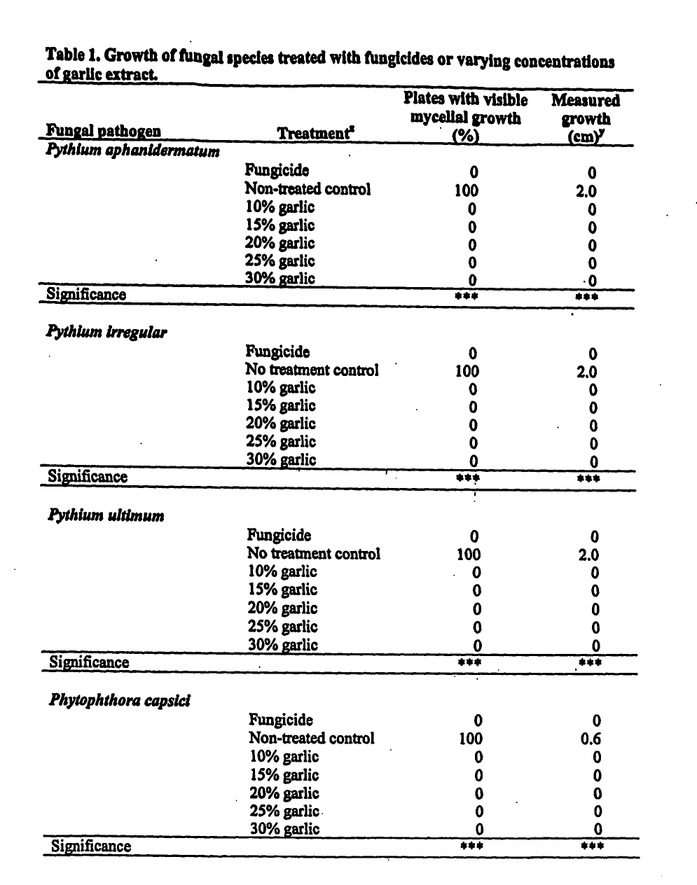

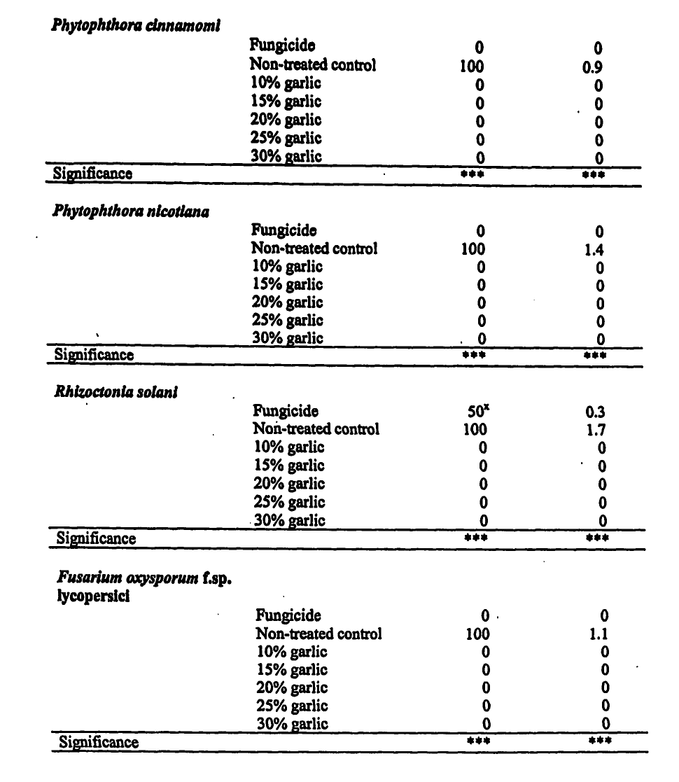

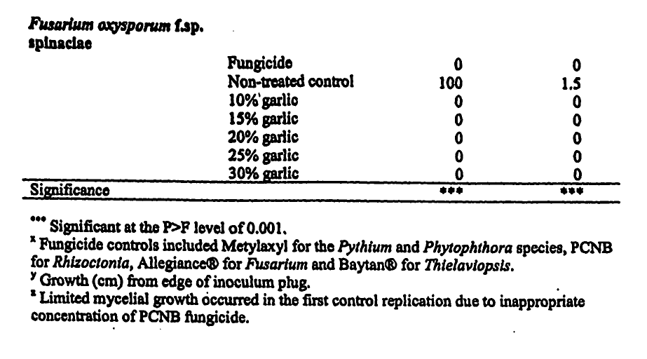

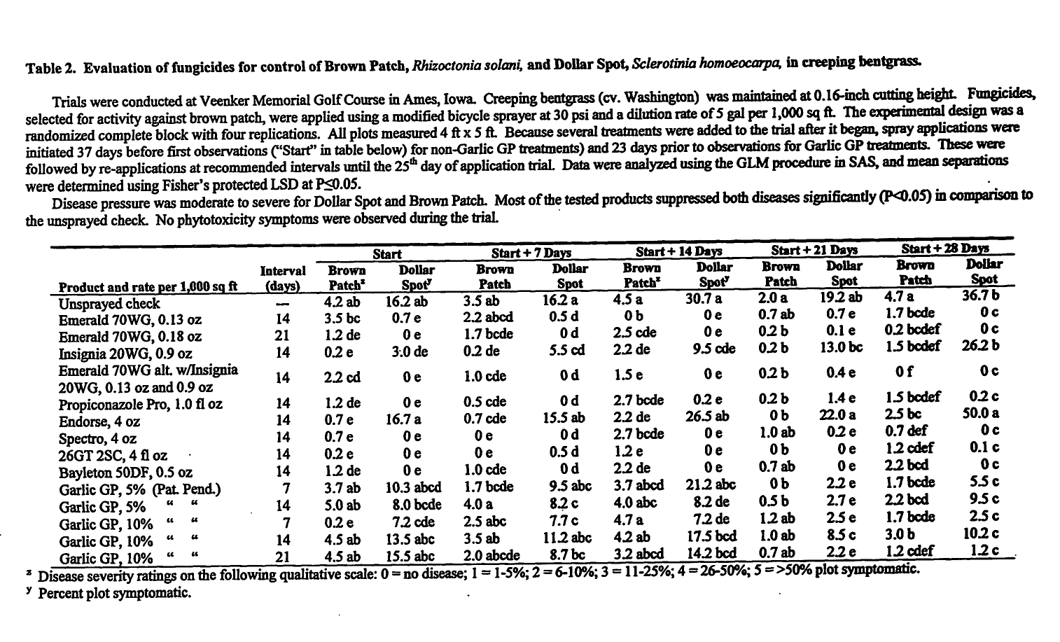

### CITATION TO PRIOR APPLICATION

This is a continuation-in-part with respect to U.S. application, Ser. No. 10/618,354, filed 11 Jul. 2003 from which priority is claimed under 35 U.S.C. §120 and under provisions of the Patent Cooperation Treaty.

### BACKGROUND OF THE INVENTION

1. Field of The Invention

The present invention relates to horticulture and floriculture, and the prevention or eradication of fungal infestation in particular.

2. Background Information

Fungal infestation is a very significant problem for plant growers. Not only are the fungal species and the plants they attack numerous and varied, the particular chemicals required are also such, and in almost all cases carry some degree of risk to users and all others who come into contact with the chemicals through residual presence, over-spray, and wind drift (in applicable circumstances).

Even though they are currently effective in many instances, even if completely innocuous to humans and animals, the continued viability of existing synthetic chemical fungicides is of concern because of developing resistance of certain fungal species.

Examples of fungal problems to plant growers are limitless, but a few examples will be provided in this context.

A problem facing tomato growers is exemplary of those facing many other food and non-food growers. The recent ban on methyl bromide leaves tomato growers susceptible to, among other problems, fusarium wilts. Some farmers have indicated an intent to simply stop farming, because profitable crops without methyl bromide seems an unlikely prospect.

Pythium is a water mold which consumes roots of plants, resulting in stunted growth and eventually plant death. Although phythium is a problem for numerous annuals and perennials, it particularly favors (and destroys) geraniums and poinsettias.

Another fungal threat is that from Phytophthora, which causes stem, crown and root rot in summer squash, winter squash (including pumpkins, pepper, tomato, and eggplant), and fruit rots on cucumber, cantaloupe, and watermelon.

Still other fungal threats to cash crops include poinsettia scab, English daisy rust, powdery mildew.

In each of the cited examples (and most others not so cited), synthetic chemical fungicides are presently the default treatment of choice, simply for lack of a known, viable alternative.

Alternatives to conventional synthetic chemical fungicides known as “biofungicides” are increasingly sited as alternatives to the increasingly suspect former class of agents. However, biofungicides are of questionable practicality. Biofungicides are bacteria based, can be very species-specific, and can exhibit serious shelf life limitations. Disincentives to development and market introduction of biofungicides include EPA registration expenses, which can range from $300,000 to $3 million.

In view of the foregoing, it would well serve everyone affected by plant grown (virtually everyone) to provide a wholly new approach to fungal prevention, control, or eradication, one which is innocuous to humans, has no adverse environmental effects, is cost effective, and, of course, is effective.

### SUMMARY OF THE INVENTION

It is an object of the present invention to provide a new method for preventing and/or treating fungal infestation of plants.

It is another object of the present invention to provide a new fungicide useful in preventing and/or treating fungal infestation of plants.

It is another object of the present invention to provide a new fungicide useful in preventing and/or treating fungal infestation of plants, which fungicide avoids the dangers associated with presently available synthetic chemical fungicides.

It is another object of the present invention to provide a new fungicide useful in preventing and/or treating fungal infestation of plants, which fungicide is substantially environmentally benign.

In satisfaction of these and related objects, the present invention provides a natural fungicide and associated method of use which, as an alternative to conventional use of synthetic chemical fungicides, provides effective prevention and eradication of fungal infestation by a wide spectrum of fungal species.

It is believed that the present natural fungicide (a garlic extract) will be exempt from EPA registration rules. This, together with its simple and readily available principle ingredient, renders the present composition a highly cost effective choice in fungal control.

### BRIEF DESCRIPTION OF THE DRAWINGS

Table 1 depicts laboratory results of investigations designed to test the efficacy of garlic extract treatment of a wide array of fungal species.

Table 2 depicts the results of trials of the present garlic extract fungal control method and formulation against dollar spot and brown patch in turf grass.

### DETAILED DESCRIPTION OF THE PREFERRED EMBODIMENT

The present invention is of a garlic extract-based, natural fungicide and associated method for preventing and/or treating fungal infestation through the use thereof.

### First Study—Cultivated Plants

To establish the efficacy of the present invention, controlled laboratory evaluations were carried out.

### Methodology

The efficacy of the garlic extract was tested against nine (9) soil-borne fungi that cause root and lower stem rots of plants. The fungal pathogens included: Pythium aphanidermatum, Pythium irregular, Pythium ultimum, Phytophthora capsici, Phytophthora cinnamomi, Phytophthora nicotiana, Rhizoctonia solani, Fusarium oxysporum fsp. lycopersici, Fusarium oxysporum f.sp. spinaciae, and Thielaviopsis basicola. All isolates used in this investigation were known to be pathogenic to various cultivated plant species.

All isolates of Pythium aphanidermatum, Pythium irregular, Pythum ultimum, Phytophthora capsici, Phytophthora cinnamomi, Phytophthora nicotiana, Rhizoctonia solani, Fusarium oxysporum f.sp. lycopersici, Fusarium oxysporum f.sp. spinaciae were grown on standard corn meal agar (CMA) for 8 to 9 days. Plugs from inoculum plates were taken using a #4 cork borer (5 mm diameter). Inoculum plugs were placed into 5-cm sterile plastic petri dishes containing 10 ml of a basal nutrient solution that consisted of 60% (v/v) clarified V-8 juice and sterile distilled water (SDW). Basal nutrient solutions were amended with the appropriate treatments. Treatments included SDW (non-treated control), a fungicidal agent appropriate to each species (metylaxyl for the Pythium and Phytophthora species, PCNB for Rhizoctonia, and Allegiance(r) for Fusarium), or 10%, 15%, 20%, 25%, or 30% (v/v) garlic extract. Cultures were placed into a growth chamber and maintained in the dark at 22(C(1(C. After 48 hours, mycelial growth (if any was visible) from culture plugs was measured.

Additionally, plugs were taken from one of the two replicate treatments for each fungal isolate for the non-treated control and the 10% garlic extract treatments, washed in SDW and placed on CMA plates to check for viability of the inoculum after 48 hours exposure to the treatments. Plates were allowed to remain in the growth chamber for eight (8) days. After eight (8) days, any additional growth from the inoculum plug was measured. All treatments were replicated twice and three repetitions of the experiments were performed.

For Thielaviopsis basicola, chlamydospores, rather than mycelial growth, were challenged with the treatments. Treatments were as listed above. However, 0.05-ml of a stock solution of chlamydospores were placed in sterile capped centrifuge tubes with 1-ml of the appropriate treatment. The fungicide control for Thielaviopsis basicola was Baytan(r). After 24 hours, tubes were spun down for 10 minutes at 13,000 rpm. A 0.1-ml sample of the concentrate was spot plated onto TBCEN agar (selective for Thielaviopsis basicola and allows for growth of this obligate parasitic fungus) in duplicate. Concentrates were then washed twice in SDW, being agitated and concentrated as described above. These washed concentrates were plated as described above to determine if the treatment resulted in death of the Thielaviopsis basicola chlamydospores. Each treatment was replicated twice.

### Results and Discussion

All Pythium and Phytophthora species tested grew on the untreated basal nutrient solution (Table 1). However, none of the Pythium and Phytophthora species placed on basal nutrient solution amended with metalaxyl or garlic extract at 10% to 30% grew from the inoculum plugs.

The Rhizoctonia species tested grew on the untreated basal nutrient solution (Table 1). In the first replication, Rhizoctonia grown on the basal nutrient solution amended with PCNB displayed a limited amount of growth due to an inappropriate PCMB concentration. However, in the second replication, Rhizoctonia did not grow on the basal nutrient solution amended with PCNB. Rhizoctonia placed on the basal nutrient solution amended with garlic extract at 10% to 30% did not grow from the inoculum plugs.

All Fusarium species tested grew on the untreated basal nutrient solution (Table 1). However, none of the Fusarium species placed on basal nutrient solution amended with Allegiance(r) fungicide or garlic extract at 10% to 30% grew from the inoculum plugs.

For all Pythium, Phytophthora, Rhizoctonia and Fusarium species tested, when plugs were removed from the treatment solutions, washed and transferred to CMA, all untreated controls grew from the plugs onto the CMA within 48 hours. However, none of those grown in basal nutrient solution amended with 10% garlic extract grew from the plugs after eight (8) days.

Therefore, garlic extract as low as 10% (v/v) inhibited mycelial growth of all of the fungal pathogens tested in this study. Additionally, even when removed from the presence of the garlic solution, fungal pathogens failed to grow and no sign of viable fungal mycelium could be observed. Thus, the garlic extract was not only fungistatic, but also fungicidal.

### Second Study—Turf Grass

Additional studies have specifically confirmed that the present garlic extract composition is effective in controlling a fungal infestations in turf grass—a problem to which significant research and substantial treatment expenditures are directed.

Reference is made to Table 2.

Table 2 depicts the results of confidential, unpublished trials of the present garlic extract fungal control method and formulation against dollar spot and brown patch in turf grass. As the results clearly show, the present garlic extract (referenced in the report as “GARLIC GP”) is highly efficacious in controlling the very problematic dollar spot and brown patch fungal species in turf grass.

This represents a landmark breakthrough in the treatment or prevention of these challenges to those who own or care for turf grass. Present methods and compositions for combating these infestations are quite expensive, and involve chemicals with reported hazards to human and animal health. As mentioned before, the presently proposed garlic extract-based treatment regimen is self-evidently safe to the environment, to humans and to animals.

### Conclusions

The above investigations establish beyond any reasonable doubt that a garlic extract solution is reliably efficacious in preventing and treating fungal infestations, both for individual cultivated plants, as well as for turf grass. Because the subject composition is wholly devoid of harmful chemical agents, regardless of the context (human or animal health, or general environmental), the present composition and associated method for preventing and treating fungal infestation represents a long-awaited, much-needed alternative to presently available fungicides.

Use of the garlic extract in lieu of conventional fungicides is straight forward. One merely sprays a light coating of the garlic extract solution over, as applicable, turf, plants leaves, stems and (optionally) on the nearby soil (as in the case of either cultivated plants or trees, such as in the case of treatments for oak wilt and related fungal infestations involving trees. Treatment may be repeated daily without any deleterious effects on any known plant, but treatments as infrequently as once weekly have thus far proven effective for some plant and fungal species.

Of course, the means of application are as varied as those for presently known fungicides, and may range from hand-held garden sprayers to fixed plumbing and nozzle assemblies, to aerial application.

Further research may establish optimal concentrations of garlic extract for specific plant and fungal species, but present indications are that concentrations as little as 10% (v/v) are adequate for preventing all tested fungal agents. Eradication of existing fungal infestations are thought to require, in some cases, concentrations a bit higher, perhaps in the 20% range.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method for controlling fungal infestation of plants comprising the steps of:
selecting a composition comprising garlic extract and a liquid carrier;
applying said composition to a plant.

2. The method of claim 1 wherein said composition contains between approximately 10% to 30% of garlic extract by volume.

3. The method of claim 1 wherein said carrier in said composition consists essentially of water.

4. The method of claim 2 wherein said carrier in said composition consists essentially of water.

5. A method for inhibiting fungal growth in a host medium comprising the steps of:
selecting a composition comprising garlic extract and a liquid carrier;
applying said composition to said host medium.

6. The method of claim 5 wherein said composition contains between approximately 10% to 30% of garlic extract by volume.

7. The method of claim 5 wherein said carrier in said composition consists essentially of water.

8. The method of claim 6 wherein said carrier in said composition consists essentially of water.

9. A fungicide consisting essentially of garlic extract and a inert liquid carrier.

10. The method of claim 9 wherein said composition contains between approximately 10% 30% of garlic extract by volume.

11. The method of claim 9 wherein said carrier in said composition consists essentially of water.

12. The method of claim 10 wherein said carrier in said composition consists essentially of water.

13. A method for inhibiting fungal grown in turf grass comprising the steps of:
selecting a composition comprising garlic extract and a liquid carrier;
applying said composition to said turf grass.

14. The method of claim 5 wherein said composition contains between approximately 10% to 3)% garlic extract by volume.

15. The method of claim 5 wherein said carrier in said composition consists essentially of water.
